(19) United States
(12) Patent Application Publication
(10) Pub. No.: US 2026/0156508 A1
(43) Pub. Date: Jun. 4, 2026

(54) CHANNEL SOUNDING DELEGATION

(71) Applicant: QUALCOMM Incorporated, San Diego, CA (US)

(72) Inventors: Mayank BATRA, Cambridge (GB); Bhargav RAGHUNATH, San Diego, CA (US); Ram Mohan KORUKONDA, Hyderabad (IN)

(21) Appl. No.: 18/965,126

(22) Filed: Dec. 2, 2024

(51) Int. Cl. H04W 24/10; H04W 74/0816; H04W 84/12

(52) U.S. Cl. CPC H04W 24/10; H04W 74/0816; H04W 84/12

(57) ABSTRACT

Various aspects of the present disclosure generally relate to wireless communication. In some aspects, a first peripheral device may receive a channel sounding request from a central device. The first peripheral device may transmit channel sounding information to a second peripheral device. The first peripheral device may receive a channel sounding result from the second peripheral device. The first peripheral device may transmit the channel sounding result to the central device. Numerous other aspects are described.

### FIELD OF THE DISCLOSURE

Aspects of the present disclosure generally relate to wireless communication and specifically relate to techniques, apparatuses, and methods associated with delegating channel sounding.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network (e.g., a wireless local area network (WLAN), such as a Wi-Fi (e.g., Institute of Electrical and Electronics Engineers (IEEE) 802.11) network) may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. “Downlink” may refer to the communication link from the AP to the station, and “uplink” may refer to the communication link from the station to the AP.

The AP may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

A wireless device may communicate using a short-range wireless protocol, such as a Bluetooth protocol, and may connect and exchange information between devices and paired devices (for example, between mobile phones, computers, digital cameras, wireless headsets, speakers, keyboards, mice or other input peripherals, and similar devices).

### SUMMARY

Some aspects described herein relate to a method of wireless communication performed by a first peripheral device. The method may include receiving a channel sounding request from a central device. The method may include transmitting channel sounding information to a second peripheral device. The method may include receiving a channel sounding result from the second peripheral device. The method may include transmitting the channel sounding result to the central device.

Some aspects described herein relate to a method of wireless communication performed by a second peripheral device. The method may include receiving channel sounding information from a first peripheral device. The method may include transmitting a channel sounding message. The method may include receiving a channel sounding response. The method may include transmitting a channel sounding result based at least in part on the channel sounding response.

Some aspects described herein relate to a method of wireless communication performed by a central device. The method may include transmitting, to a first peripheral device, a channel sounding request that indicates delegation of channel sounding to a second peripheral device. The method may include receiving, from the first peripheral device, a channel sounding result for the second peripheral device.

Some aspects described herein relate to an apparatus for wireless communication at a first peripheral device. The apparatus may include one or more memories and one or more processors coupled to the one or more memories. The one or more processors may be individually or collectively configured to receive a channel sounding request from a central device. The one or more processors may be configured to transmit channel sounding information to a second peripheral device. The one or more processors may be individually or collectively configured to receive a channel sounding result from the second peripheral device. The one or more processors may be individually or collectively configured to transmit the channel sounding result to the central device.

Some aspects described herein relate to an apparatus for wireless communication at a second peripheral device. The apparatus may include one or more memories and one or more processors coupled to the one or more memories. The one or more processors may be individually or collectively configured to receive channel sounding information from a first peripheral device. The one or more processors may be individually or collectively configured to transmit a channel sounding message. The one or more processors may be individually or collectively configured to receive a channel sounding response. The one or more processors may be individually or collectively configured to transmit a channel sounding result based at least in part on the channel sounding response.

Some aspects described herein relate to an apparatus for wireless communication at a central device. The apparatus may include one or more memories and one or more processors coupled to the one or more memories. The one or more processors may be individually or collectively configured to transmit, to a first peripheral device, a channel sounding request that indicates delegation of channel sounding to a second peripheral device. The one or more processors may be individually or collectively configured to receive, from the first peripheral device, a channel sounding result for the second peripheral device.

Some aspects described herein relate to a non-transitory computer-readable medium that stores a set of instructions for wireless communication by a first peripheral device. The set of instructions, when executed by one or more processors of the first peripheral device, may cause the first peripheral device to receive a channel sounding request from a central device. The set of instructions, when executed by one or more processors of the first peripheral device, may cause the first peripheral device to transmit channel sounding information to a second peripheral device. The set of instructions, when executed by one or more processors of the first peripheral device, may cause the first peripheral device to receive a channel sounding result from the second peripheral device. The set of instructions, when executed by one or more processors of the first peripheral device, may cause the first peripheral device to transmit the channel sounding result to the central device.

Some aspects described herein relate to a non-transitory computer-readable medium that stores a set of instructions for wireless communication by a second peripheral device. The set of instructions, when executed by one or more processors of the second peripheral device, may cause the second peripheral device to receive channel sounding information from a first peripheral device. The set of instructions, when executed by one or more processors of the second peripheral device, may cause the second peripheral device to transmit a channel sounding message. The set of instructions, when executed by one or more processors of the second peripheral device, may cause the second peripheral device to receive a channel sounding response. The set of instructions, when executed by one or more processors of the second peripheral device, may cause the second peripheral device to transmit a channel sounding result based at least in part on the channel sounding response.

Some aspects described herein relate to a non-transitory computer-readable medium that stores a set of instructions for wireless communication by a central device. The set of instructions, when executed by one or more processors of the central device, may cause the central device to transmit, to a first peripheral device, a channel sounding request that indicates delegation of channel sounding to a second peripheral device. The set of instructions, when executed by one or more processors of the central device, may cause the central device to receive, from the first peripheral device, a channel sounding result for the second peripheral device.

Some aspects described herein relate to an apparatus for wireless communication. The apparatus may include means for receiving a channel sounding request from a central device. The apparatus may include means for transmitting channel sounding information to another apparatus. The apparatus may include means for receiving a channel sounding result from the other apparatus. The apparatus may include means for transmitting the channel sounding result to the central device.

Some aspects described herein relate to an apparatus for wireless communication. The apparatus may include means for receiving channel sounding information from another apparatus. The apparatus may include means for transmitting a channel sounding message. The apparatus may include means for receiving a channel sounding response. The apparatus may include means for transmitting a channel sounding result based at least in part on the channel sounding response.

Some aspects described herein relate to an apparatus for wireless communication. The apparatus may include means for transmitting, to a first peripheral device, a channel sounding request that indicates delegation of channel sounding to a second peripheral device. The apparatus may include means for receiving, from the first peripheral device, a channel sounding result for the second peripheral device.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 shows a wireless communication network, in accordance with the present disclosure.

FIG. 2 illustrates an example of a wireless communication network that supports low-latency parameter updates for extended personal audio networks in accordance with the present disclosure.

FIG. 3 is a diagram illustrating an example of a wireless communication device, in accordance with the present disclosure.

FIG. 4 is a diagram illustrating an example of peripheral connections, in accordance with the present disclosure.

FIG. 5 is a diagram illustrating an example associated with channel sounding delegation, in accordance with the present disclosure.

FIGS. 6A, 6B, 6C, and 6D are diagrams illustrating an example of channel sounding delegation, in accordance with the present disclosure.

FIGS. 7A and 7B are diagrams illustrating an example of channel sounding delegation to peer devices, in accordance with the present disclosure.

FIG. 8 is a diagram illustrating an example process performed, for example, at a first peripheral device or an apparatus of a first peripheral device, in accordance with the present disclosure.

FIG. 9 is a diagram illustrating an example process performed, for example, at a second peripheral device or an apparatus of a second peripheral device, in accordance with the present disclosure.

FIG. 10 is a diagram illustrating an example process performed, for example, at a central device or an apparatus of a central device, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A central device (e.g., user equipment (UE) or handset) may have an asynchronous connectionless link (ACL) with a first peripheral device (e.g., primary earbud) that is paired with a second peripheral device (e.g., secondary earbud) using a basic rate (BR)/enhanced data rate (EDR) link. In some topologies, only the primary earbud has a BR/EDR ACL and a low energy (LE) protocol ACL connection with the central device. The secondary earbud is not visible to the central device. Channel sounding may require an LE ACL connection between devices. This means that the central device can measure the distance to the primary earbud but not measure a distance to the secondary earbud. As a result, the central device is unable to locate the secondary earbud, and a user of the central device is not able to locate the secondary earbud with a “find my device” application.

Various aspects relate generally to locating devices. Some aspects more specifically relate to delegating channel sounding of the second peripheral device. The first peripheral device may delegate the channel sounding to the second peripheral device, which performs channel sounding on behalf of the first peripheral device. The central device may transmit a channel sounding request. The channel sounding request may indicate that channel sounding is to be delegated to the second peripheral device. The first peripheral device may transmit channel sounding information to the second peripheral device. The channel sounding information may include one or more parameters for the channel sounding.

The second peripheral device may perform channel sounding, as delegated by the first peripheral device. The second peripheral device may generate a channel sounding result (e.g., ranging data for determining the distance and/or the direction from the central device) based at least in part on the channel sounding. The second peripheral device may transmit the channel sounding result. The first peripheral device may transmit the channel sounding result to the central device. The first peripheral device may indicate that the channel sounding result is for the second peripheral device, as part of the delegation of the channel sounding. The central device may compute the distance/direction by feeding the channel sounding result into a distance/direction calculating algorithm.

Particular aspects of the subject matter described in this disclosure can be implemented to realize one or more of the following potential advantages. By delegating channel sounding of the second peripheral device (no ACL connection to the central device) to the first peripheral device (has an ACL connection to the central device), the central device may obtain distance and/or location information of the second peripheral device that the central device would not have been able to obtain due to the absence of an ACL connection between the central device and the second peripheral device. As a result, the central device can now provide location information for the second peripheral device to the user of the central device.

Several aspects of wireless communication networks will now be presented with reference to various apparatuses and techniques. These apparatuses and techniques will be described in the following detailed description and illustrated in the accompanying drawings by various blocks, modules, components, circuits, steps, processes, and/or algorithms, among other examples (collectively referred to as “elements”). These elements may be implemented using hardware, software, or combinations thereof. Whether such elements are implemented as hardware or software depends upon the particular application and design constraints imposed on the overall system.

In some wireless communication networks, a wireless communication device (WCD) may support applications associated with low-latency or lossless audio to one or more other devices, such as one or more personal audio devices. For example, a wireless communication device may support applications and use cases associated with ultra-low-latency (ULL), such as ULL gaming, or streaming lossless audio to one or more personal audio devices (for example, peripheral devices) of a user. In scenarios in which a user uses two peripheral devices, the wireless communication device may support an extended personal audio network (XPAN) via which the wireless communication device may communicate with the two peripheral devices. To meet latency or lossless criteria associated with an application or use case, XPAN devices may employ a target wake time (TWT) technique for communication between the wireless communication device and the peripheral devices. In some systems, the peripheral devices and the wireless communication device may exchange one or more Bluetooth (BT) messages and implement a complete TWT teardown between the wireless communication device and each of the peripheral devices. Such an exchange of Bluetooth messages and TWT teardown may introduce too much latency for some applications, such as ULL gaming or streaming lossless audio applications.

In some examples, a wireless communication device (WCD), which may be a handset or an access point (AP) (for example, a soft AP (SAP)), and a set of peripheral devices (for example, earbuds or audio devices) may use downlink audio data packets to carry updated TWT parameters or any other XPAN-related parameters that the wireless communication device and the peripheral devices may indicate via wireless signaling. Additionally, or alternatively, the wireless communication device may embed a set of updated parameters in a padding section of an audio data packet and may transmit the audio data packet to the peripheral devices. The peripheral devices may each acknowledge the audio data packet transmitted by the wireless communication device, and the wireless communication device may communicate in accordance with the updated parameters based on receiving acknowledgements from each of the peripheral devices.

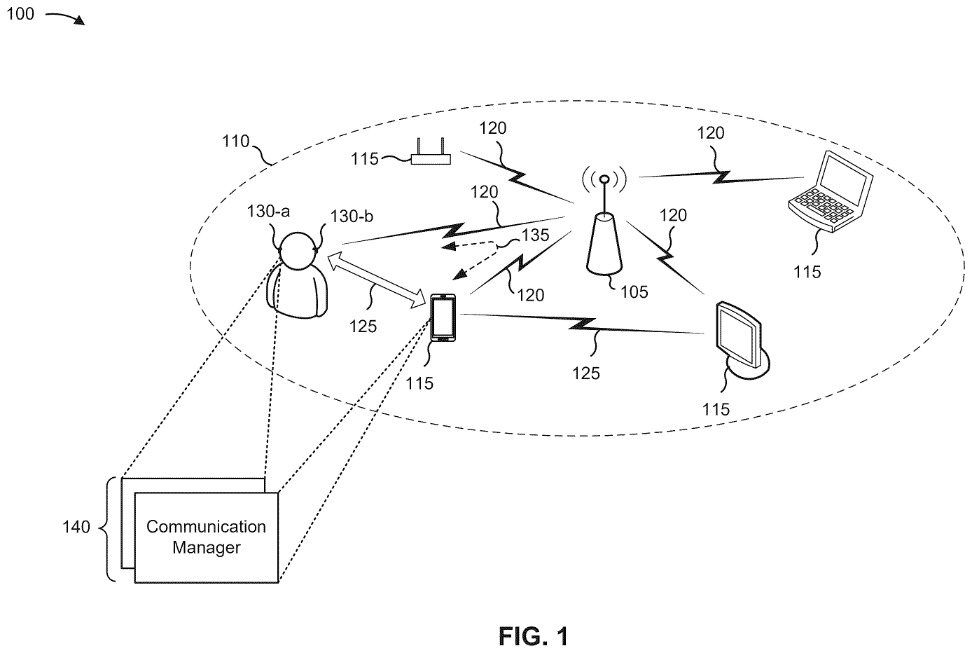

FIG. 1 shows a wireless communication network 100, in accordance with the present disclosure. The wireless communication network 100 may be a wireless local area network (WLAN) or a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11 ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include a central device 105 (e.g., AP, Bluetooth network entity) and multiple associated devices 115 (such as stations (STAs) or SAPs). The devices 115 may include mobile stations, UEs, personal digital assistants (PDAs), other handheld devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and/or vehicles, among other examples.

The central device 105 and the associated devices 115 (for example, associated STAs) may represent a basic service set (BSS) or an extended service set (ESS). A BSS includes devices that communicate with each other, and an ESS may include multiple BSSs or one or more BSSs and associated wired networks. The various devices 115 in the network are able to communicate with one another through the central device 105. The central device 105 may support a coverage area 110, which may represent a basic service area (BSA) of the wireless communication network 100. An extended network station (not shown) associated with the wireless communication network 100 may be connected to a wired or wireless distribution system that may allow multiple central devices 105 to be connected in an ESS.

While only one central device 105 is shown in FIG. 1, the wireless communication network 100 can include multiple central devices 105. The central device 105 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Although not shown in FIG. 1, a device 115 may be located in the intersection of more than one coverage area 110 and may associated with more than one central device 105. A single AP and an associated set of devices 115 may be referred to as a BSS. A distribution system (not shown) may be used to connect APs in an ESS. In some cases, the coverage area 110 of an AP may be divided into sectors (also not shown). The wireless communication network 100 may include APs of different types (for example, a metropolitan area, or a home network) with varying and/or overlapping coverage areas 110. Two devices 115 may also communicate directly via a direct wireless communication link 125 regardless of whether both devices 115 are in the same coverage area 110. Examples of direct wireless communication links 120 may include Wi-Fi Direct connections, Wi-Fi Tunneled Direct Link Setup (TDLS) links, and other group connections. Devices 115 and APs may communicate according to the

WLAN radio and baseband protocol for physical and medium access control (MAC) layers from IEEE 802.11 and versions including 802.11b, 802.11g, 802.11a, 802.11n, 802.11ac, 802.11ad, 802.11ah, and/or 802.11ax, among other examples. In other implementations, peer-to-peer connections or ad hoc networks may be implemented within wireless communication network 100.

In some cases, a device 115 (or an AP) may be detectable by a central AP, but not by other devices 115 in the coverage area 110 of the central AP. For example, one device 115 may be at one end of the coverage area 110 of the central AP while another device 115 may be at the other end. Thus, both devices 115 may communicate with the AP, but may not receive the transmissions of the other. This may result in colliding transmissions for the two devices 115 in a contention-based environment (for example, carrier sense multiple access with collision avoidance (CSMA/CA)) because the devices 115 may not refrain from transmitting on top of each other. A device 115 whose transmissions are not identifiable, but that is within the same coverage area 110 may be known as a hidden node. CSMA/CA may be supplemented by the exchange of a request-to-send (RTS) packet transmitted by a sending device 115 (or AP) and a clear-to-send (CTS) packet transmitted by the receiving device 115 (or AP). This may alert other devices within range of the sender and receiver not to transmit for the duration of the primary transmission. Thus, RTS and/or CTS may help mitigate a hidden node problem.

The wireless communication network 100 may include a central device 105, devices 115 (for example, which may be referred to as source devices or central devices), and paired devices 115 (for example, which may be referred to as sink devices or peripheral devices) implementing WLAN communications (for example, Wi-Fi communications) and/or Bluetooth communications. For example, devices 115 may include cell phones, UEs, STAs, mobile stations, PDAs, other handheld devices, netbooks, notebook computers, tablet computers, laptops, or some other suitable devices. Paired devices 115 may include Bluetooth-enabled devices capable of pairing with other Bluetooth-enabled devices (for example, such as devices 115), which may include wireless audio devices (for example, headsets, earbuds, speakers, earpieces, headphones), display devices (for example, televisions or computer monitors), microphones, meters, and/or valves, among other examples. As one example, the paired devices 115 may include a wireless audio device 130-a and a wireless audio device 130-b as shown by FIG. 1 (for example, wireless earbuds), and the paired devices 115 may alternatively or additionally communicate with the central device 105. In some aspects, a paired device 115 may communicate with a device 115 using the central device 105.

“Bluetooth communications” may refer to a short-range communication protocol and may be used to connect and exchange information between devices 115 and paired devices 115 (for example, between mobile phones, computers, digital cameras, wireless headsets, speakers, keyboards, mice or other input peripherals, and similar devices). Bluetooth systems (for example, aspects of wireless communication network 100) may be organized using a central-peripheral relationship employing a time-division duplex protocol having, for example, defined time slots of 625 microseconds, in which transmission alternates between the central device (for example, a device 115) and one or more peripheral devices (for example, paired devices 115). In some examples, “device” 115 may generally refer to a central device, and “paired device” 115 may refer to a peripheral device in the wireless communication network 100. Therefore, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communication network 100. Generally, “device” 115 may refer to a wireless communication device capable of wirelessly exchanging data signals with another device (for example, a paired device 115), and “paired device” 115 may refer to a device operating in a peripheral role, or to a short-range wireless communication device capable of exchanging data signals with the device 115 (for example, using Bluetooth communication protocols).

A communication link 125 may be established between two Bluetooth-enabled devices (for example, between a device 115 and a paired device 115) and may provide for communications or services (for example, according to some Bluetooth profiles). The communication link may use, for example, a Bluetooth LE audio protocol for transferring audio (point-to-point or by broadcast). The controller stack may be responsible for setting up communication links 125, such as asynchronous connection-oriented links (or asynchronous connection-oriented connections), synchronous connection-orientated (SCO) links (or SCO connections), extended synchronous connection-oriented (eSCO) links (or eSCO connections), and/or other logical transport channel links. For example, a Bluetooth connection may be an eSCO connection for voice calls (for example, which may allow for retransmission), and/or an asynchronous connection-less (ACL) connection for music streaming (for example, advanced audio distribution profile (A2DP)), among other examples. eSCO packets may be transmitted in predetermined time slots (for example, 6 Bluetooth slots each for eSCO). The regular interval between the eSCO packets may be specified when the Bluetooth link is established. The eSCO packets to/from a specific device (for example, paired device 115) are acknowledged and may be retransmitted if not acknowledged during a retransmission window. In addition, audio may be streamed between a device 115 and a paired device 115 using an ACL connection (for example, an A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (for example, providing considerably reduced power consumption and cost while maintaining a similar communication range), human interface device (HID) profile (for example, providing low latency links with low power requirements), etc.

A device 115 may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via an AP (for example, over communication links 120). The AP and the associated devices 115 may represent a BSS or an ESS. The various devices 115 in the network may be able to communicate with one another through the AP. In some cases the AP may be associated with a coverage area, which may represent a BSA.

Devices 115 and APs may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, and/or 802.11ax. In other examples, peer-to-peer connections or ad hoc networks may be implemented within wireless communication network 100, and devices may communicate with each other via communication links 120 (for example, Wi-Fi Direct connections, Wi-Fi TDLS links, peer-to-peer communication links, or other peer or group connections). An AP may be coupled to a network (such as the Internet) and may enable a device 115 to communicate via the network (or communicate with other devices 115 coupled to the AP). A device 115 may communicate with a network device bi-directionally. For example, in a WLAN, a device 115 may communicate with an associated central device 105 via downlink (for example, the communication link from the central device 105 to the device 115) and uplink (for example, the communication link from the device 115 to the central device 105).

In some examples, content, media, and/or audio, among other examples, exchanged between a device 115 and a paired device 115 may originate from a WLAN. In some examples, device 115 may receive audio from a central device 105 (for example, via WLAN communications), and the device 115 may then relay or pass the audio to the paired device 115 (for example, via Bluetooth communications and/or the central device 105). As one example, the device 115 may relay or pass the audio to the paired device 115 via the direct wireless communication link 125. Alternatively, or additionally, the device 115 may relay and/or pass the audio to the paired device via the central device 105 as shown by reference number 135. In some examples, certain types of Bluetooth communications (for example, such as high quality or high definition (HD) Bluetooth) may require enhanced quality of service. For example, in some examples, delay-sensitive Bluetooth traffic may have a higher priority than WLAN traffic.

In some examples, a wireless communication device (for example, the central device 105 and/or a device 115) may support applications associated with low-latency or lossless audio to one or more other devices, such as one or more personal audio devices. For example, a wireless communication device may support applications and use cases associated with ULL, such as ULL gaming, or streaming lossless audio to one or more personal audio devices (for example, peripheral devices) of a user or one or more headset devices (for example, AR/VR/MR/XR headset devices). In scenarios in which a user uses two or more peripheral devices (for example, a wireless audio device 130-a and a wireless audio device 130-b), the wireless communication device may support an XPAN enabling communication with the two or more peripheral devices.

To meet latency or lossless criteria associated with an application or use case, XPAN devices may employ a TWT technique for communication between the wireless communication device and the peripheral devices. Initial or default TWT parameters may be set under an expectation for ideal (for example, interference-free or approximately interference-free) conditions and may be updated in response to changing channel conditions or a changing concurrency situation at the wireless communication device. In some systems, the peripheral devices and the wireless communication device may exchange one or more Bluetooth messages and implement a complete TWT teardown between the wireless communication device and each of the peripheral devices. Such an exchange of Bluetooth messages and TWT teardown may introduce too much latency for some applications, such as ULL gaming or streaming lossless audio applications.

In some examples, a wireless communication device, which may be a device 115 (for example, a handset) or a central device 105, and a set of peripheral devices may use downlink audio data packets to carry updated TWT parameters or any other XPAN-related parameters that the wireless communication device and the peripheral devices may indicate via wireless signaling. In some examples, the wireless communication device may embed a set of updated parameters (for example, updated TWT parameters or other parameters associated with the XPAN) in one or more fields, such as one or more contributing source (CSRC) fields, of a real-time transport protocol (RTP) audio header of an audio data packet and may transmit the audio data packet to the peripheral devices. Additionally, or alternatively, the wireless communication device may embed a set of updated parameters in a padding section of an audio data packet and may transmit the audio data packet to the peripheral devices. The peripheral devices may each acknowledge the audio data packet transmitted by the wireless communication device and the wireless communication device may communicate in accordance with the updated parameters based on receiving acknowledgements from each of the peripheral devices.

In accordance with the example implementations described herein, various devices may use over-the-air transmissions to indicate updated parameters (for example, updated XPAN-related parameters, such as updated TWT parameters) via one or both of RTP audio header CSRC fields or padding fields in a payload data section. Consequently, the various devices may use a sequence of over-the-air packet transmissions to change or update a set of parameters (for example, a set of TWT parameters). For example, via audio data packet transmissions, the various devices may configure, trigger, or indicate an increase or a decrease in audio packet periodicity (for example, when TWT service interval (SI) is changed). Further, in accordance with the described techniques, such devices may avoid an explicit TWT teardown, request, and response frame exchange and may instead achieve a TWT sequence change after RTP audio header CSRC fields or a padding section indicates updated TWT parameters.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices (for example, one or more devices 115, central devices 105, and/or one or more servers, and/or one or more components of a cloud computing network, among other examples). For example, in an deployment where AI/ML functionality is performed independently at a device, sometimes referred to as “overlay AI/ML”, the AI/ML model (or an instance or portion of the AI/ML model) may be deployed at a device, one or more servers, and/or one or more components of a cloud computing network, among other examples. Additionally or alternatively, in a deployment where AI/ML functionality is coordinated between different devices, sometimes referred to as “coordinated AI/ML”, or performed at all device and network layers, sometimes referred to as “native AI/ML”, the AI/ML model (or an instance of the AI/ML model) may be deployed at multiple devices (for example, a first portion of the AI/ML model may be deployed at a central device 105 and a second portion of the AI/ML model may be deployed at a network entity). In other examples of coordinated AI/ML and/or native AI/ML, a first AI/ML model may be deployed at a central device 105 and a second AI/ML model may be deployed at a network entity. The AI/ML model(s) may be configured to enhance various aspects of the wireless communication network (for example, to increase privacy, reliability, and/or efficient use of network bandwidth, and/or to reduce latency, among other examples). For example, the AI/ML model(s) may be trained to identify patterns or relationships in data corresponding to the wireless communication network, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a central device or a peripheral device, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a first peripheral device (e.g., a device 115) may include a communication manager 140. As described in more detail elsewhere herein, the communication manager 140 may receive a channel sounding request from a central device; transmit channel sounding information to a second peripheral device; receive a channel sounding result from the second peripheral device; and transmit the channel sounding result to the central device. Additionally, or alternatively, the communication manager 140 may perform one or more other operations described herein.

In some aspects, a second peripheral device (e.g., a device 115) may include a communication manager 140. As described in more detail elsewhere herein, the communication manager 140 may receive channel sounding information from a first peripheral device; transmit a channel sounding message; receive a channel sounding response; and transmit a channel sounding result based at least in part on the channel sounding response. Additionally, or alternatively, the communication manager 140 may perform one or more other operations described herein.

In some aspects, a central device (e.g., a central device 105) may include a communication manager 140. As described in more detail elsewhere herein, the communication manager 140 may transmit, to a first peripheral device, a channel sounding request that indicates delegation of channel sounding to a second peripheral device; and receive, from the first peripheral device, a channel sounding result for the second peripheral device. Additionally, or alternatively, the communication manager 140 may perform one or more other operations described herein.

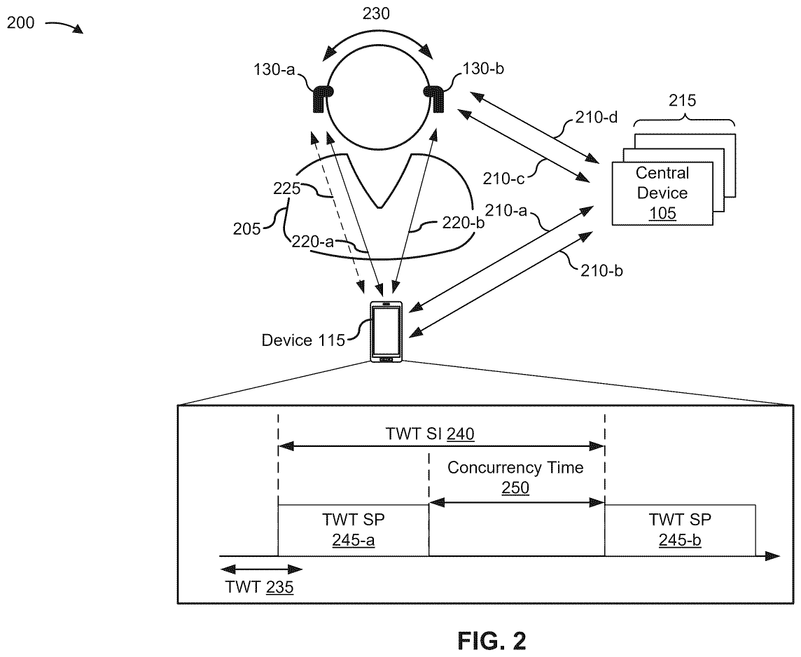

FIG. 2 illustrates an example of a wireless communication network 200 that supports low-latency parameter updates for extended personal audio networks in accordance with the present disclosure. The wireless communication network 200 may implement or be implemented to realize aspects of the wireless communication network 100. For example, the wireless communication network 200 illustrates communication between a central device 105, a device 115 (for example, a handset or handheld device), and a wireless audio device 130-a and a wireless audio device 130-b of a user 205 (for example, examples of audio devices and/or peripheral devices), which may be examples of corresponding devices as illustrated by and described with reference to FIG. 1. In some examples, the device 115, the wireless audio device 130-a, and the wireless audio device 130-b may support a signaling-based mechanism according to which the device 115 may transmit an indication of a set of updated parameters to each of the wireless audio device 130-a and the wireless audio device 130-b via one or audio data packets.

In some examples, the device 115 may communicate with the central device 105 via one or both of a link 210-a and a link 210-b, which may be examples of infrastructure links between the central device 105 and the device 115. Alternatively, or additionally, the central device 105 may communicate with the wireless audio device 130-a and/or the wireless audio device 130-b via one or both of a link 210-c and a link 210-d, respectively. In some examples, the wireless audio device 130-a and the wireless audio device 130-b may be connected to a same central device 105 as the device 115. In other aspects, the wireless audio device 130-a and the wireless audio device 130-b may be connected to a different central device 105 than the device 115. Accordingly, and as shown by reference number 215, the device 115, the wireless audio device 130-a, and/or the wireless audio device 130-b may communicate with one another via multiple APs 105. The link 210-a may be an example of a 2.4 GHz link between the central device 105 and the device 115, and the link 210-b may be an example of a 5 GHz link or a 6 GHz link between the central device 105 and the device 115. In some examples, the link 210-c and/or the link 210-d may be a 2.4 GHz link, a 5 GHz, and/or a 6 GHz link.

The device 115 may communicate wirelessly with each of the wireless audio device 130-a and the wireless audio device 130-b, where each of the wireless audio device 130-a and the wireless audio device 130-b may be associated with an XPAN of the device 115. For example, the device 115 may communicate with the wireless audio device 130-a via a link 220-a and may communicate with the wireless audio device 130-b via a link 220-b, where the link 220-a and the link 220-b may be referred to or understood as XPAN links. The link 220-a may be an example of a 5 GHz link or a 6 GHz link and the link 220-b may be an example of a 5 GHz link or a 6 GHz link. Additionally, in some examples, the device 115 may communicate with the wireless audio device 130-a, which may be an example of a primary earbud, via a communication link 225. The communication link 225 may be an example of a Bluetooth link between the device 115 and the wireless audio device 130-a. The wireless audio device 130-a and the wireless audio device 130-b, which may be an example of a secondary audio device, may communicate with each other via a link 230, which may be an example of a Bluetooth link between the wireless audio device 130-a and the wireless audio device 130-b.

The device 115 may communicate with the wireless audio device 130-a and/or the wireless audio device 130-b via one or more central devices 105. To illustrate, the device 115 may communicate with a first central device 105 via the link 210-a and/or the link 210-b. The first central device 105 may be connected to a second central device 105, and the second central device 105 may be connected to the wireless audio device 130-a and/or the wireless audio device 130-b via the link 210-c and/or the link 210-d. Accordingly, the device 115 may communicate with the wireless audio device 130-a and/or the wireless audio device 130-b based at least in part on communicating with the first central device 105, the first central device 105 communicating with the second central device 105, and the second central device 105 communicating with the wireless audio device 130-a and/or the wireless audio device 130-b. However, in other examples, the device 115, the wireless audio device 130-a, and/or the wireless audio device 130-b may be connected to a same central device 105.

In some examples, the device 115, the wireless audio device 130-a, and the wireless audio device 130-b may support or belong to an XPAN and may use the XPAN to support one or more applications or use cases, such as applications or use cases associated with latency or lossless audio constraints or criteria. For example, the device 115 may support one or more use cases of ULL gaming and streaming lossless audio to the wireless audio device 130-a and the wireless audio device 130-b (for example, personal devices of the device 115). For such applications, the device 115 may be expected to keep end-to-end latency below a relatively stringent latency target (for example, 40 milliseconds (ms) for ULL gaming). Further, the device 115 may also be tasked with handling (for example, gracefully handling without a hard disconnect and/or

loss of data) a coexistence of XPAN traffic (for example, traffic to or from one or both of the wireless audio device 130-a and the wireless audio device 130-b) with other concurrency scenarios the user 205 or the system may initiate. Such other concurrency scenarios may include a scan concurrency for channel selection, STA infrastructure link concurrency for online gaming or other traffic to or from the central device 105, or neighbor aware networking (NAN) discovery and NAN data transfer, or any combination thereof.

The device 115 may hav an operating condition and/or an operating specification to meet, such as a data transfer latency operating condition for various applications or use cases (for example, an ultra-low-latency constraint for a ULL gaming use case) and also facilitate coexistence between XPAN and other concurrency scenarios on the device 115. To meet the latency operating condition associated with, for example, ULL gaming, a power constraint of the wireless audio device 130-a and the wireless audio device 130-b, and/or power and concurrency constraints at the device 115, the device 115 may employ a TWT technique for the communication between the device 115 (which may act or function as an SAP) and each of the wireless audio device 130-a and wireless audio device 130-b (which may act or function as STAs). Alternatively, or additionally, the device 115 may employ one or more power saving mode time synchronization techniques as described below.

Example TWT parameters include a TWT 235, a TWT SI 240, and a TWT service period (SP) 245. A TWT 235 may indicate or be associated with a timing synchronization function (TSF) time indicating a start or beginning of a first TWT session. A TWT SI 240 may indicate a TWT interval, which may refer to a time difference between a start or beginning of two consecutive TWT sessions. A TWT SP 245 may indicate a duration during which one or both of the wireless audio device 130-a and the wireless audio device 130-b are awake during a TWT SI 240. In some aspects, a TWT SP 245 may be referred to or understood as a TWT session. As illustrated by FIG. 2, the TWT SI 240 may indicate a time difference between a TWT SP 245-a and a TWT 245-b. A remainder of time within a TWT SI 240 excluding a TWT SP 245 may be referred to or understood as a concurrency time 250 during which the device 115 may perform any operations (for example, transmission or reception) associated with a concurrency scenario at the device 115. In other words, the difference between XPAN TWT SI 240 and XPAN TWT SP 245 may be the time left for the device 115 to support other concurrencies (for example, outside of any channel switching or software overheads).

For XPAN, each of the wireless audio device 130-a and the wireless audio device 130-b (which may be examples of TWT requesting STAs) may initiate a TWT session with the device 115 (which may be an example of a TWT responding STA). Further, for low-latency use cases (for example, ULL gaming use cases), a target end-to-end latency may be relatively stringent (for example, less than or equal to approximately 40 ms), which may be tied to, associated with, or expect a Wi-Fi latency in a specific range (for example, in the sub-10 ms range). To achieve such a Wi-Fi latency, a TWT SI 240 and a TWT SP 245 may be selected or set to specific values (for example, a TWT SI 240 may be set to 4 ms with a TWT SP 245 of 2 ms). Further, for a lossless audio use case, for example, a TWT SI 240 may be set to approximately 70 ms with a TWT SP 245 of approximately 23 ms.

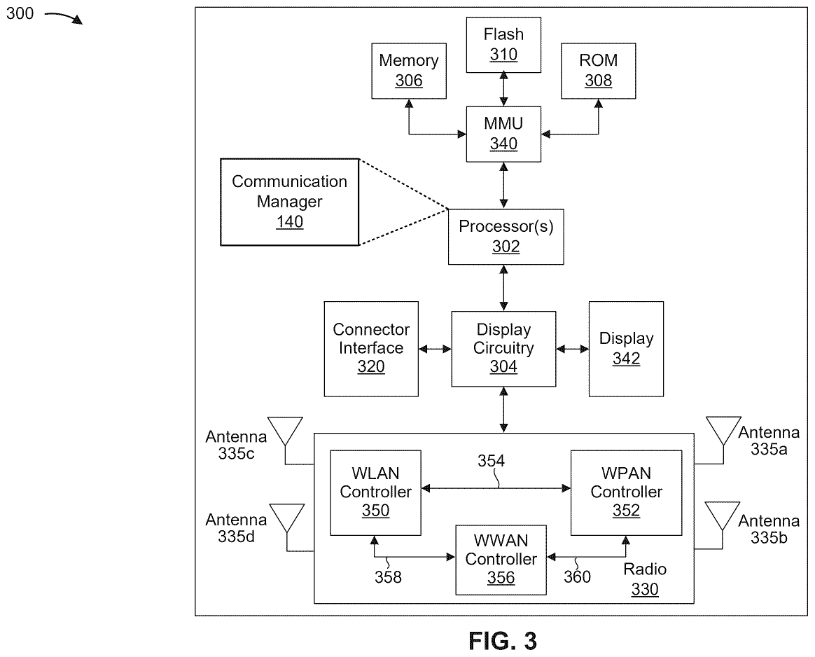

FIG. 3 is a diagram illustrating an example of a wireless communication device 300, in accordance with the present disclosure. In some aspects, the wireless communication device 300 may be an example of the central device 105, the device 115, and/or the wireless audio device 130 described above. In some examples, the central device 105, the device 115, and/or the wireless audio device 130 may include one or more wireless communication devices 300 and/or one or more components of wireless communication device 300.

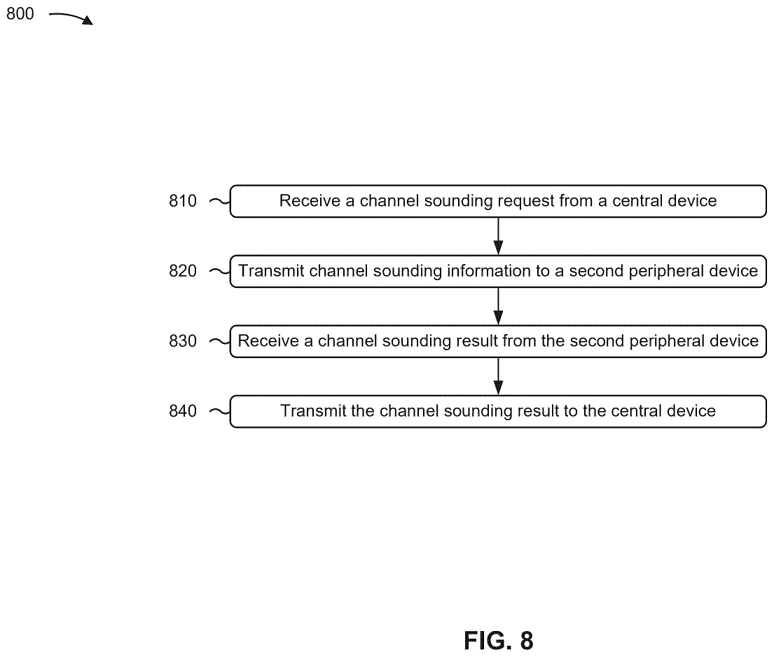

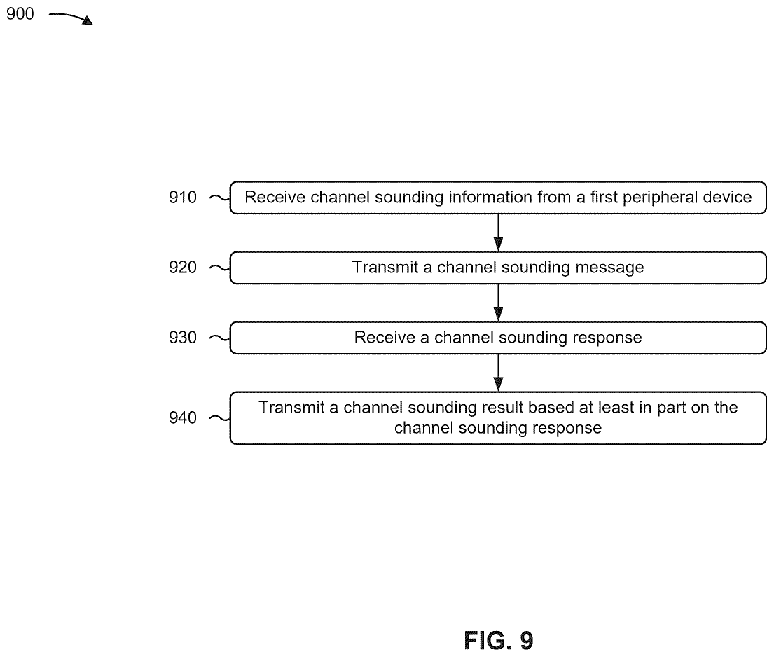

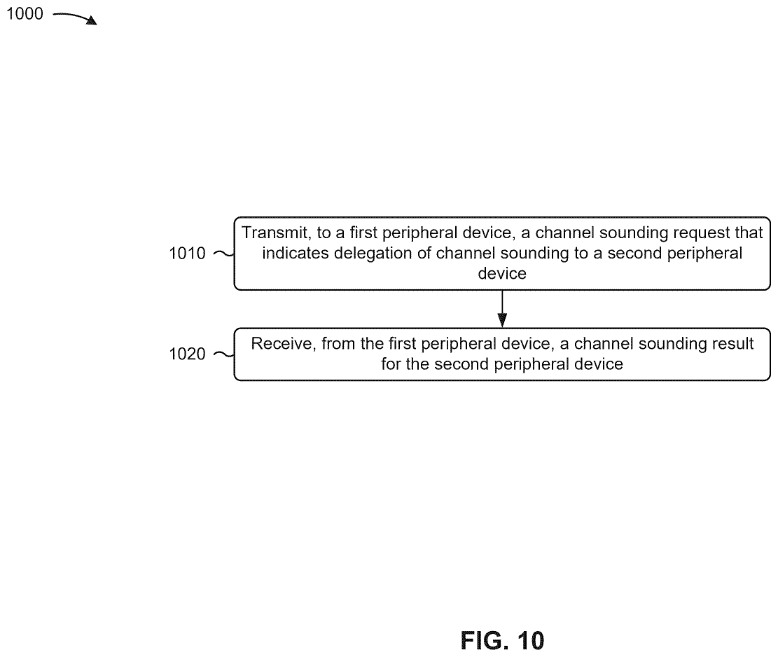

In some examples, the wireless communication device 300 is configured to perform process 800 of FIG. 8, process 900 of FIG. 9, process 1000 of FIG. 10, or other processes as described herein. The wireless communication device 300 may include one or more chips, system-on-chips (SoCs), chipsets, packages, components or devices that individually or collectively constitute or comprise a processing system. The processing system may interface with other components of the wireless communication device 300, and may generally process information (such as inputs or signals) received from such other components and output information (such as outputs or signals) to such other components. In some examples, an example chip may include a processing system, a first interface to output or transmit information and a second interface to receive or obtain information. For example, the first interface may refer to an interface between the processing system of the chip and a transmission component, such that the wireless communication device 300 may transmit the information output from the chip. In such an example, the second interface may refer to an interface between the processing system of the chip and a reception component, such that the wireless communication device 300 may receive information that is passed to the processing system. In some such examples, the first interface also may obtain information, such as from the transmission component, and the second interface also may output information, such as to the reception component.

As shown in FIG. 3, the wireless communication device 300 may include processor (or “processing”) circuitry in the form of one or multiple processors, such as processor(s) 302. The processor (or “processing”) circuitry may be in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processor(s) 302 may execute program instructions for the wireless communication device 300. One or more of the processor(s) 302 may be individually or collectively configurable or configured to perform various functions or operations described herein. A group of processor(s) 302 collectively configurable or configured to perform a set of functions may include a first processor configurable or configured to perform a first function of the set and a second processor configurable or configured to perform a second function of the set, or may include the group of processors all being configured or configurable to perform the set of functions.

The wireless communication device 300 may also include a display 342 that can perform graphics processing and present information to a user. The processor(s) 302 may also be coupled to memory management unit (MMU) 340, which may be configured to receive addresses from the processor(s) 302 and translate the addresses to address locations in memory such as memory 306, read-only memory (ROM) 308, or flash memory 310 and/or to address locations in other circuits or devices, such as the display circuitry 304, radio 330, connector interface 320, and/or display 342. The MMU 340 may also be configured to perform memory protection and page table translation or set up. In some aspects, the MMU 340 may be included as a portion of the processor(s) 302. In some aspects, the wireless communication device 300 may include a communication manager (for example, communication manager 140) that controls the wireless communication device 300 or processor(s) 302 to perform the processes described herein.

In some examples, the processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”), such as the memory 306, ROM 308, and/or flash memory 310. One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The processor(s) 302 may be coupled to other circuits of the wireless communication device 300. For example, the wireless communication device 300 may include various memory types, a connector interface 320 through which the wireless communication device 300 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a WPAN subsystem, and/or a cellular subsystem (such as a Long-Term Evolution (LTE) or New Radio (NR) subsystem). The wireless communication device 300 may include multiple antennas 335a, 335b, 335c, and/or 335d for performing wireless communication with, for example, wireless communication devices in a WPAN.

The wireless communication device 300 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field-programmable gate array (FPGA), and/or an application specific integrated circuit (ASIC).

In certain aspects, the radio 330 may include separate controllers configured to control communications for various respective radio access technology (RAT) protocols. For example, as shown in FIG. 3, radio 330 may include a WLAN controller 350 that manages WLAN communications, a WPAN controller 352 that manages Bluetooth, BLE, and/or other suitable WPAN communications, and a wireless wide area network (WWAN) controller 356 that manages WWAN communications. In some aspects, the wireless communication device 300 may store and execute a WLAN software driver for controlling WLAN operations performed by the WLAN controller 350, a WPAN software driver for controlling WPAN operations performed by the WPAN controller 352, and/or a WWAN software driver for controlling WWAN operations performed by the WWAN controller 356.

In some aspects, a first coexistence interface 354 (such as a wired interface) may be used for sending information between the WLAN controller 350 and the WPAN controller 352. Additionally, or alternatively, in some aspects, a second coexistence interface 358 may be used for sending information between the WLAN controller 350 and the WWAN controller 356. Additionally, or alternatively, in some aspects, a third coexistence interface 360 may be used for sending information between the WPAN controller 352 and the WWAN controller 356. In some examples, one or more of the WLAN controller 350, the WPAN controller 352, and/or the WWAN controller 356 may be implemented as hardware, software, firmware or some combination thereof.

In some aspects, the WLAN controller 350 may be configured to communicate with a second device in a WPAN using a WLAN link using one or more, some, or all of the antennas 335a, 335b, 335c, and 335d. In other configurations, the WPAN controller 352 may be configured to communicate with at least one second device in a WPAN using one or more, some, or all of the antennas 335a, 335b, 335c, and 335d. In other configurations, the WWAN controller 356 may be configured to communicate with a second device in a WPAN using one or more, some, or all of the antennas 335a, 335b, 335c, and 335d. The WLAN controller 350, the WPAN controller 352, and/or the WWAN controller 356 may be configured to adjust a wakeup time interval and a shutdown time for the wireless communication device 300.

A short-range wireless communications protocol, such as BT, BLE, and/or BR/EDR, may include and/or may use one or more other communications protocols, for example, to establish and maintain communications links. In some examples, the wireless communication device 300 may establish a communications link with one or more peripheral devices, such as a wireless headset or wireless earbuds, according to at least one communications protocol for short-range wireless communications. In some aspects, the communications link may include a communications link that adheres to a protocol included and/or for use with BT, BLE, and/or BR/EDR, among other examples. In one aspect, the communications link may include an asynchronous connection-oriented logical transport, sometimes referred to as an ACL link. When operating as an ACL link, the communications link may allow the wireless communication device 300 to connect or “pair” with a peripheral device. The connection is asynchronous in that the two devices may not need to synchronize, timewise, data communications between each other to permit communication of data packets via the communications link.

In some examples, a logical link control and adaptation protocol (L2CAP) may be used within a BT protocol stack (not shown in FIG. 3). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some examples, the communications link may include an A2DP link. For example, an A2DP link may provide a point-to-point link between a source device, such as the wireless communication device 300, and a sink device, such as the wireless earbuds 130-a and 130-b. With an A2DP link, data packets including audio may be transmitted over an ACL channel, and other information (for example, for controlling the audio stream) may be transmitted over a separate control channel. The data packets may occur non-periodically.

In some examples, the communications link may support synchronous logical transport mechanisms between a source device and a peripheral device. For example, a communications link may include an SCO link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience. Accordingly, in some aspects, the communications link may include an eSCO link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link may include an isochronous (ISO) link. When operating as an ISO link, the communications link may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, a first peripheral device (e.g., a device 115) includes means for receiving a channel sounding request from a central device; means for transmitting channel sounding information to a second peripheral device; means for receiving a channel sounding result from the second peripheral device; and/or means for transmitting the channel sounding result to the central device. In some aspects, the means for the wireless communication device 300 to perform operations described herein may include, for example, one or more of antennas 335a-335d, WPAN controller 352, WLAN controller 350, radio 330, and/or processor 302, among other examples.

In some aspects, a second peripheral device (e.g., a device 115) includes means for receiving channel sounding information from a first peripheral device; means for transmitting a channel sounding message; means for receiving a channel sounding response; and/or means for transmitting a channel sounding result based at least in part on the channel sounding response. In some aspects, the means for the wireless communication device 300 to perform operations described herein may include, for example, one or more of antennas 335a-335d, WPAN controller 352, WLAN controller 350, radio 330, and/or processor 302, among other examples.

In some aspects, a central device (e.g., a central device 105) includes means for transmitting, to a first peripheral device, a channel sounding request that indicates delegation of channel sounding to a second peripheral device; and/or means for receiving, from the first peripheral device, a channel sounding result for the second peripheral device. In some aspects, the means for the wireless communication device 300 to perform operations described herein may include, for example, one or more of antennas 335a-335d, WPAN controller 352, WLAN controller 350, radio 330, and/or processor 302, among other examples.

The number and arrangement of components shown in FIG. 3 are provided as an example. In practice, device 300 may include additional components, fewer components, different components, or differently arranged components than those shown in FIG. 3. Additionally, or alternatively, a set of components (for example, one or more components) of device 300 may perform one or more functions described as being performed by another set of components of device 300.

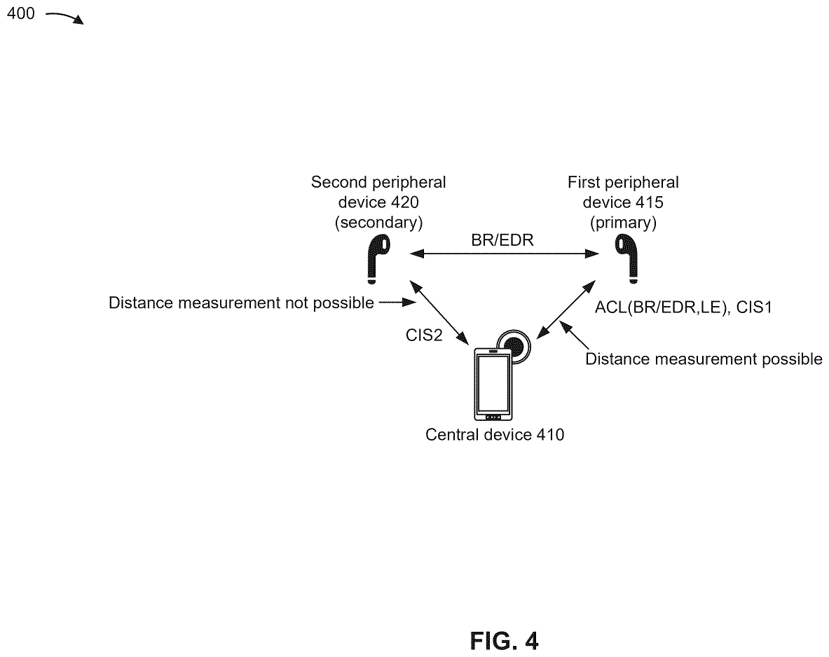

FIG. 4 is a diagram illustrating an example 400 of peripheral connections, in accordance with the present disclosure.

A central device 410 (e.g., UE or handset) may have an ACL with a first peripheral device 415 (e.g., primary earbud) that is paired with a second peripheral device 420 (e.g., secondary earbud) using a BR/EDR link. In TrueWireless Mirroring (TWM) and split connected isochronous group (CIG) topologies, only the primary earbud has a BR/EDR ACL and an LE ACL connection with the central device 410. The secondary earbud is not visible to the central device 410. Channel sounding as specified in BT 6.0 requires an LE ACL connection between devices. This means that the central device 410 can measure the distance to the primary earbud but not measure a distance to the secondary earbud. As a result, the central device 410 is unable to locate the secondary earbud, and a user of the central device 410 is not able to locate the secondary earbud with a “find my device” application.

As indicated above, FIG. 4 is provided as an example. Other examples may differ from what is described with regard to FIG. 4.

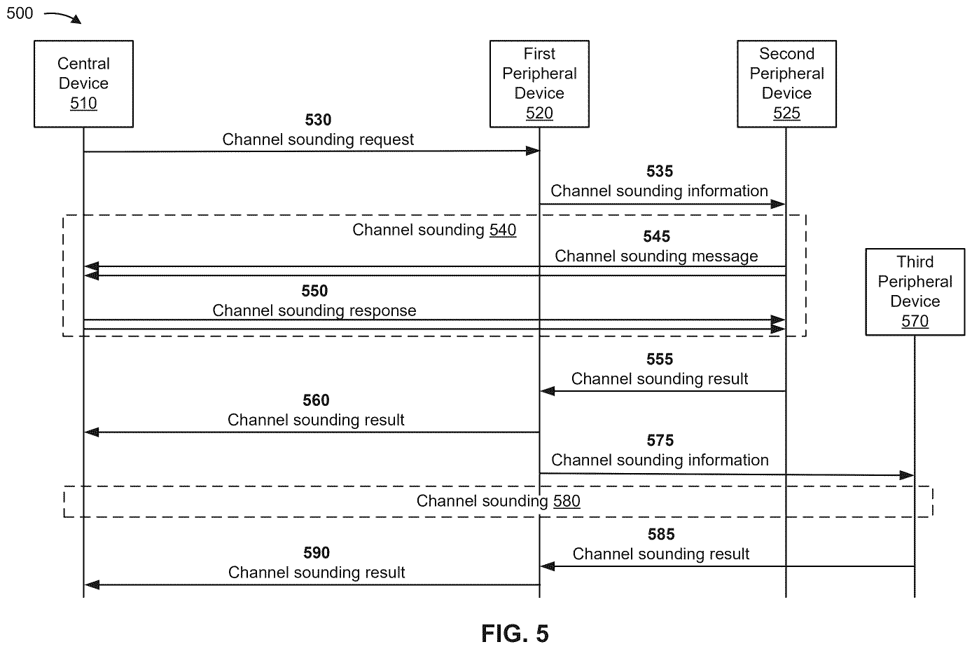

FIG. 5 is a diagram illustrating an example 500 associated with channel sounding delegation, in accordance with the present disclosure. As shown in FIG. 5, a central device 510 (e.g., central device 105) and a first peripheral device 520 (e.g., device 115) may communicate with one another (e.g., via an ACL connection). The first peripheral device 520 may be paired with a second peripheral device 525.

According to various aspects described herein, the channel sounding of the second peripheral device 525 may be delegated from a central device 510 to the first peripheral device 520. The first peripheral device 520 may delegate the channel sounding to the second peripheral device 525, which performs channel sounding on behalf of the first peripheral device 520.

The channel sounding delegation is shown by example 500. As shown by reference number 530, the central device 510 may transmit, and the first peripheral device 520 may receive, a channel sounding request. The channel sounding request may indicate that channel sounding is to be delegated to the second peripheral device 525. As shown by reference number 535, the first peripheral device 520 may transmit, and the second peripheral device 525 may receive, channel sounding information. The channel sounding information may include one or more parameters for the channel sounding.

As shown by reference number 540, the second peripheral device 525 may perform channel sounding, as delegated by the first peripheral device 520. A procedure for the channel sounding 540 may include the second peripheral device 525 transmitting one or more channel sounding messages, as shown by reference number 545, and receiving one or more corresponding channel sounding responses, as shown by reference number 550. The second peripheral device 525 may generate a channel sounding result (e.g., ranging data for determining a distance from the central device 510 and/or direction) based at least in part on the channel sounding 540. As shown by reference number 555, the second peripheral device 525 may transmit, and the first peripheral device 520 may receive, the channel sounding result. As shown by reference number 560, the first peripheral device 520 may transmit, and the central device 510 may receive, the channel sounding result. The first peripheral device 520 may indicate that the channel sounding result is for the second peripheral device 525, as part of the delegation of the channel sounding. The central device 510 may compute the distance/direction by feeding the channel sounding result into a distance/direction calculating algorithm.

By delegating channel sounding of the second peripheral device 525 (no ACL connection to the central device 510) to the first peripheral device 520 (has an ACL connection to the central device 510), the central device 510 may obtain distance and/or location information of the second peripheral device 525 that the central device 510 would not have been able to obtain due to the absence of an ACL connection between the central device 510 and the second peripheral device 525. As a result, the central device 510 can now provide location information for the second peripheral device 525 to the user of the central device 510.

In some aspects, channel sounding may be delegated to other peripheral devices. The first peripheral device 520 may transmit the channel sounding information to one or more other peripheral devices. As shown by reference number 575, the first peripheral device 520 may transmit the channel sounding information to other peripheral devices, such as a third peripheral device 570 (e.g., device 115). The third peripheral device 570 may perform channel sounding 580, as shown by reference number 540. The channel sounding 580 may include the third peripheral device 570 transmitting channel sounding messages to the central device 510 (and/or other devices) and receiving the corresponding channel sounding responses. The third peripheral device 570 may generate a channel sounding result (e.g., distance) from the perspective of the third peripheral device 570. As shown by reference number 585, the third peripheral device 570 may transmit, and the first peripheral device 520 may receive, the channel sounding result. As shown by reference number 590, the first peripheral device 520 may transmit, and the central device 510 may receive, the channel sounding result. By delegating channel sounding to other peripheral devices, the central device 510 may obtain location information for other peripheral devices that do not have an ACL connection with the central device 510.

As indicated above, FIG. 5 is provided as an example. Other examples may differ from what is described with respect to FIG. 5.

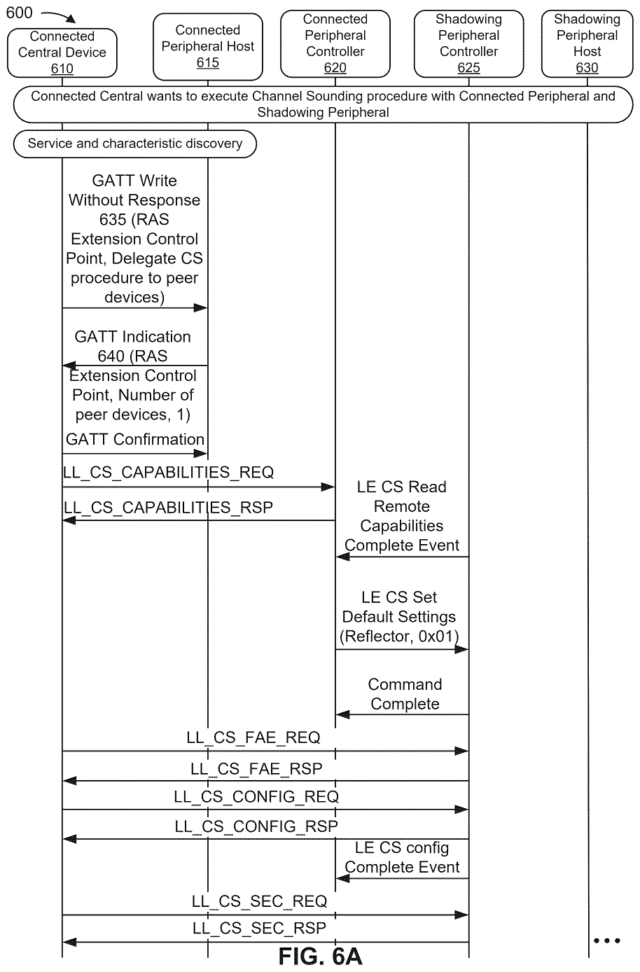

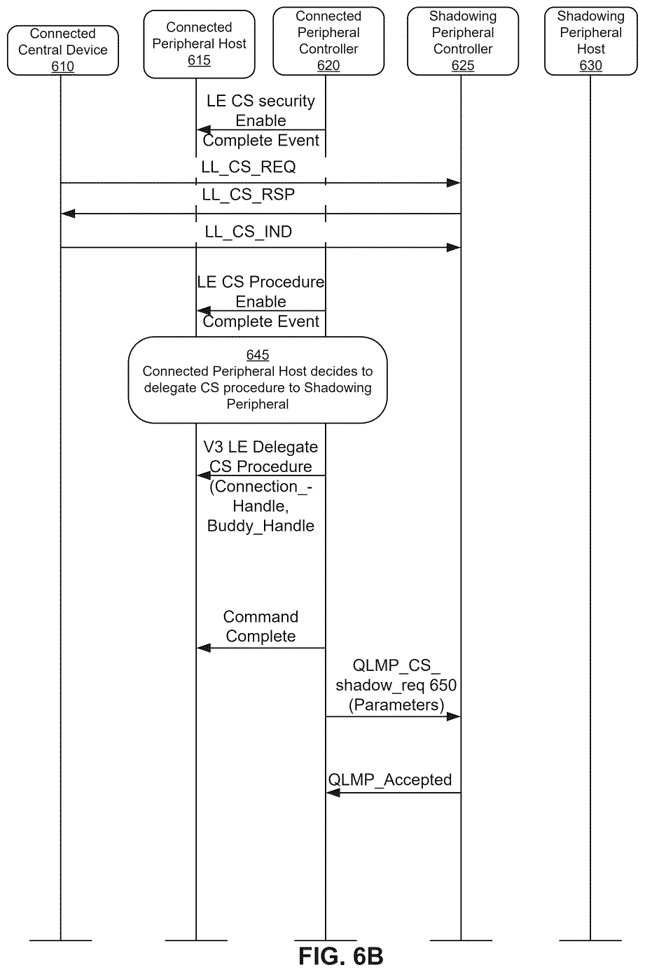

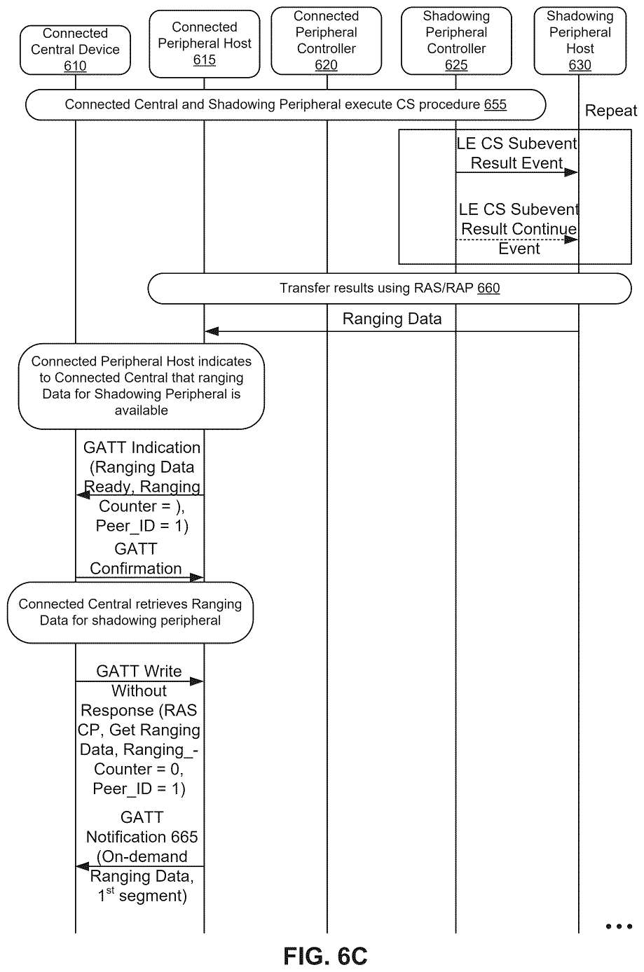

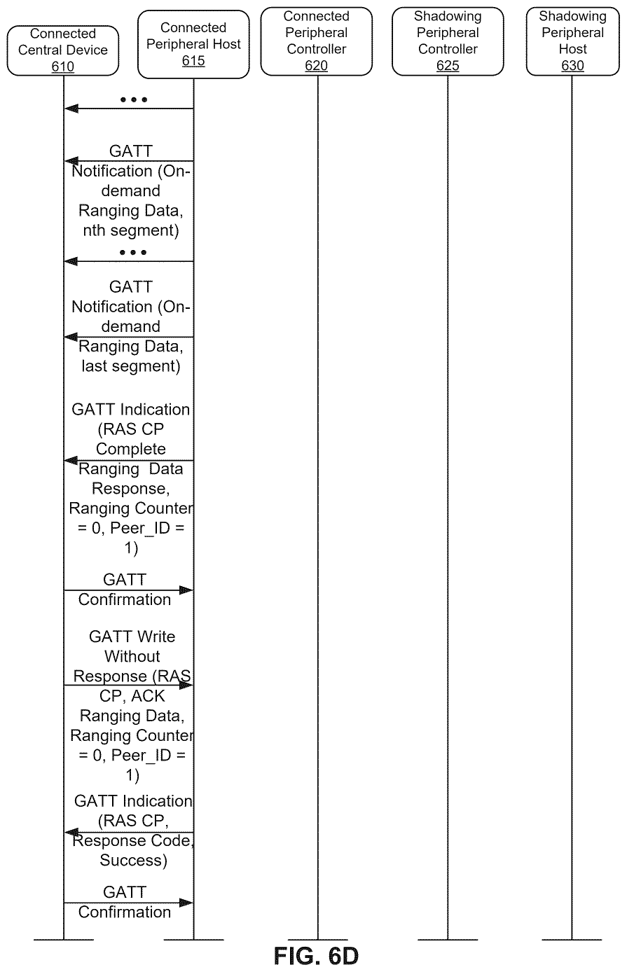

FIGS. 6A, 6B, 6C, and 6D are diagrams illustrating an example 600 of channel sounding delegation, in accordance with the present disclosure. Example 600 shows a connected central device 610 (e.g., central device 510) that is connected to a connected peripheral host 615. The connected peripheral host 615 and the connected peripheral controller 620 may be part of a first peripheral device (e.g., first peripheral device 520)

that has an ACL connection with the connected central device 610. The first peripheral device may be paired with a second peripheral device (e.g., second peripheral device 525) that is shadowing the connected peripheral device. The shadowing peripheral device may include a shadowing peripheral controller 625 and a shadowing peripheral host 630.

Example 600 shows signaling associated with the connected peripheral device delegating the channel sounding to the shadowing peripheral device. The connected peripheral device may provide channel sounding information that indicates one or more parameters for a ranging service and a profile. The parameters may include, for example, a value in a channel map (ChM) field, which specifies which of the (e.g., 37) advertising channels the central device will use for communication. This helps the devices agree on the channels to be used for the connection. Fields in a message (e.g., LL_CS_CONFIG_REQ protocol data unit (PDU)) may help to configure the connection between the central and peripheral devices, ensuring synchronization, power efficiency, and/or error handling during the BLE connection setup process. Other parameters may include ChM_Repetition (indicates a repetition rate for the ChM field), Main_Mode (indicates a mode of operation), Sub_Mode (indicates a more granular mode in which the connection layer is operating), and/or Main_Mode_Min_Steps (indicates a minimum number of steps that can be taken during a connection procedure or a configuration procedure). Additional parameters may include Main_Mode_Max_Steps, Main_Mode_Repetition, Mode_0_Steps (indicates an initial configuration phase or a default mode for setting up a connection), CS_SYNC_PHY (indicates the synchronized PHY mode between two BLE devices during the connection establishment phase), RTT_Type (indicates an RTT (Round-Trip Time) measurement or RTT-related operation within the context of the BT connection setup), Role (central or peripheral), ChSel (indicates a channel selection algorithm used to choose the appropriate set of channels during the connection establishment), Ch3cShape (indicates shaping or configuring channel 3 during the connection setup phase), and/or Ch3cJump (indicates how the device jumps between channels, starting from channel 3).

Parameters in the channel sounding information may include T_IP1 (indicates a timer that defines a connection interval or a time period), T_IP2, T_FCS (indicates a timer or time parameter related to frame check sequence (FCS) handling or timing in the BLE connection setup process), T_PM (indicates a timer related to power management during the connection setup phase of BLE communication), T_SW (indicates a timer related to switching events in BLE communication), Reference_Clock (BT clock value of the connected peripheral from which the CIS_Offset or CS_Offset is measured), Offset, Event_Interval, Subevents_Per_Event, Subevent_Interval, Subevent_Len, ACI (indicates an advertising channel index (ACI) in BLE communication), PHY, Pwr_Delta, K_DRBG (indicates a key for a deterministic random bit generator (DRBG) used in the context of secure key generation or random number generation in BLE communication), and/or V_DRBG (indicates the value or state output from a DRBG).

The connected central device 610 may transmit, as a channel sounding request for delegating channel sounding, a generic attribute profile (GATT) write without response message 635, as shown in example 600 of FIG. 6A. The request may indicate a ranging service (RAS) extension control point. The connected peripheral host 615 may receive the request and provide a response in a GATT indication message 640. In example 600, the number of peer devices for channel sounding delegation is one. However, channel sounding may be delegated to multiple peripheral or peer devices. Capability information may be exchanged.

As shown by reference number 645 in FIG. 6B, the connected peripheral host 615 may determine to delegate channel sounding to the shadowing peripheral device. Accordingly, the connected peripheral controller 620 may transmit, to delegate channel sounding, channel sounding information to the shadowing peripheral controller 625 in a link measurement protocol channel sounding shadow request message 650. As shown by reference number 655 in FIG. 6C, the shadowing peripheral controller 625 may perform channel sounding with the connected central device 610. As shown by reference number 660, the shadowing peripheral device may transfer the channel sounding result as part of the RAS or a ranging profile (RAP). The shadowing peripheral device may also transmit ranging data. The connected peripheral host 615 may transmit the channel sounding result (e.g., ranging data) in a GATT notification message 665. As shown by FIG. 6D, ranging data may be transmitted for multiple segments.

As indicated above, FIGS. 6A, 6B, 6C, and 6D are provided as an example. Other examples may differ from what is described with regard to FIGS. 6A, 6B, 6C, and 6D.

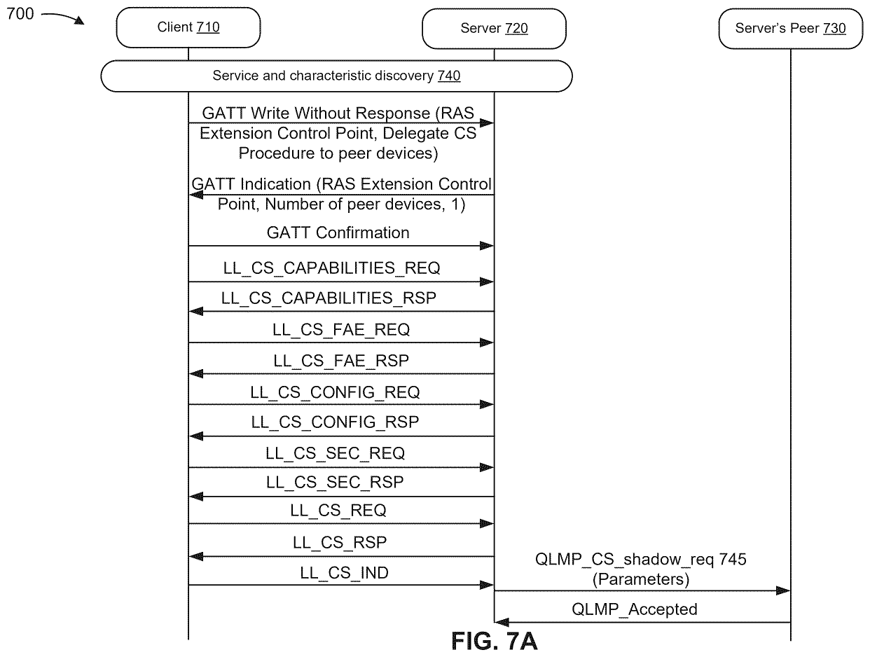

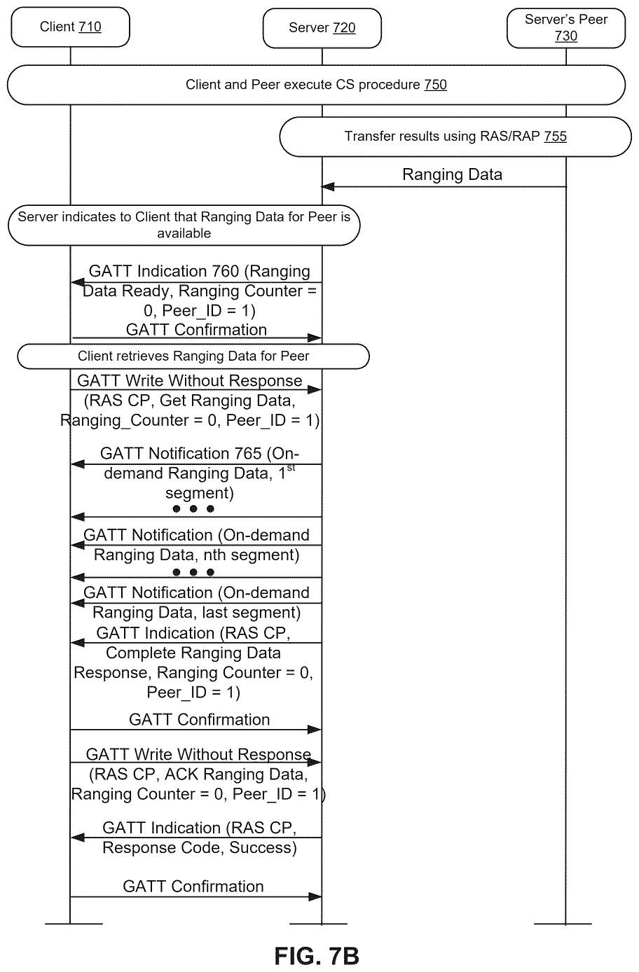

FIGS. 7A and 7B are diagrams illustrating an example 700 of channel sounding delegation to peer devices, in accordance with the present disclosure.

In some aspects, a client 710 may discover a server 720 (shown by reference number 740 in FIG. 7A) and transmit a number of peer devices opcode to the server 720 to delegate channel sounding to the peer devices (e.g., server's peer 730). The opcode, in some scenarios, may not include any parameters. Upon receiving the opcode, the server 720 may transmit the opcode and then delegate one or more channel sounding procedures to its peer devices, such as server's peer 730. For example, the server 720 may transmit a QLMP channel sounding request message 745 to the server's peer 730. This delegation may apply, for example, to a primary earbud delegating one or more channel sounding procedures to a secondary earbud upon receiving this opcode.

Once a delegated channel sounding procedure 750 is complete, the server 720 may transfer the ranging data from the peer device (server's peer 730) to the client 710, as shown by reference number 755 in FIG. 7B. The server 720 may indicate that a channel sounding result (e.g., ranging data) for the server's peer 730 is available in a GATT indication message 760. The server 720 may transmit the ranging data in a GATT notification message 765. Other segments and a confirmation may be transmitted.

As indicated above, FIGS. 7A and 7B are provided as an example. Other examples may differ from what is described with respect to FIGS. 7A and 7B.

FIG. 8 is a diagram illustrating an example process 800 performed, for example, at a first peripheral device or an apparatus of a first peripheral device, in accordance with the present disclosure. Example process 800 is an example where the apparatus or the first peripheral device (e.g., first peripheral device 520) performs operations associated with channel sounding delegation.

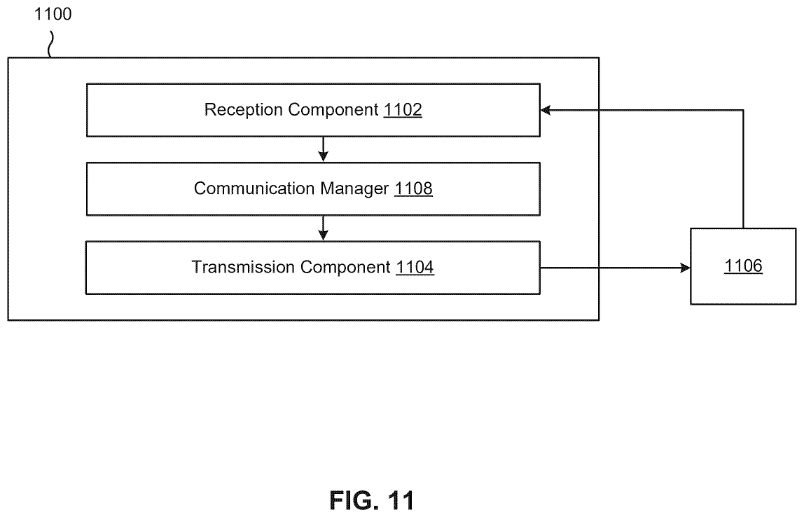

As shown in FIG. 8, in some aspects, process 800 may include receiving a channel sounding request from a central device (block 810). For example, the first peripheral device (e.g., using reception component 1102 and/or communication manager 1106, depicted in FIG. 11) may receive a channel sounding request from a central device, as described above.

As further shown in FIG. 8, in some aspects, process 800 may include transmitting channel sounding information to a second peripheral device (block 820). For example, the first peripheral device (e.g., using transmission component 1104 and/or communication manager 1106, depicted in FIG. 11) may transmit channel sounding information to a second peripheral device, as described above.

As further shown in FIG. 8, in some aspects, process 800 may include receiving a channel sounding result from the second peripheral device (block 830). For example, the first peripheral device (e.g., using reception component 1102 and/or communication manager 1106, depicted in FIG. 11) may receive a channel sounding result from the second peripheral device, as described above.

As further shown in FIG. 8, in some aspects, process 800 may include transmitting the channel sounding result to the central device (block 840). For example, the first peripheral device (e.g., using transmission component 1104 and/or communication manager 1106, depicted in FIG. 11) may transmit the channel sounding result to the central device, as described above.

Process 800 may include additional aspects, such as any single aspect or any combination of aspects described below and/or in connection with one or more other processes described elsewhere herein.

In a first aspect, the channel sounding request includes an indication to delegate channel sounding to the second peripheral device.

In a second aspect, alone or in combination with the first aspect, the channel sounding request indicates a number of peer devices for channel sounding.

In a third aspect, alone or in combination with one or more of the first and second aspects, process 800 includes transmitting the channel sounding information to one or more other peripheral devices based at least in part on the number of peer devices.

In a fourth aspect, alone or in combination with one or more of the first through third aspects, process 800 includes receiving a respective channel sounding result from each of the one or more other peripheral devices, and transmitting each of the respective channel sounding results to the central device.

In a fifth aspect, alone or in combination with one or more of the first through fourth aspects, the first peripheral device has an ACL to the central device on behalf of both the first peripheral device and the second peripheral device.

In a sixth aspect, alone or in combination with one or more of the first through fifth aspects, the channel sounding result includes ranging data for the second peripheral device.

In a seventh aspect, alone or in combination with one or more of the first through sixth aspects, the channel sounding information includes one or more parameters that the second peripheral device is to use for delegating channel sounding.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a second peripheral device or an apparatus of a second peripheral device, in accordance with the present disclosure. Example process 900 is an example where the apparatus or the second peripheral device (e.g., second peripheral device 525) performs operations associated with channel sounding delegation.

As shown in FIG. 9, in some aspects, process 900 may include receiving channel sounding information from a first peripheral device (block 910). For example, the second peripheral device (e.g., using reception component 1102 and/or communication manager 1106, depicted in FIG. 11) may receive channel sounding information from a first peripheral device, as described above.

As further shown in FIG. 9, in some aspects, process 900 may include transmitting a channel sounding message (block 920). For example, the second peripheral device (e.g., using transmission component 1104 and/or communication manager 1106, depicted in FIG. 11) may transmit a channel sounding message, as described above.

As further shown in FIG. 9, in some aspects, process 900 may include receiving a channel sounding response (block 930). For example, the second peripheral device (e.g., using reception component 1102 and/or communication manager 1106, depicted in FIG. 11) may receive a channel sounding response, as described above.

As further shown in FIG. 9, in some aspects, process 900 may include transmitting a channel sounding result based at least in part on the channel sounding response (block 940). For example, the second peripheral device (e.g., using transmission component 1104 and/or communication manager 1106, depicted in FIG. 11) may transmit a channel sounding result based at least in part on the channel sounding response, as described above.

Process 900 may include additional aspects, such as any single aspect or any combination of aspects described below and/or in connection with one or more other processes described elsewhere herein.

In a first aspect, the channel sounding information includes an indication that channel sounding is delegated to the second peripheral device.

In a second aspect, alone or in combination with the first aspect, the channel sounding information indicates one or more parameters for channel sounding.

In a third aspect, alone or in combination with one or more of the first and second aspects, the first peripheral device has an ACL to a central device on behalf of both the first peripheral device and the second peripheral device.

In a fourth aspect, alone or in combination with one or more of the first through third aspects, the channel sounding result includes ranging data for the second peripheral device.

In a fifth aspect, alone or in combination with one or more of the first through fourth aspects, the channel sounding information includes one or more parameters that the second peripheral device is to use for delegating channel sounding.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a central device or an apparatus of a central device, in accordance with the present disclosure. Example process 1000 is an example where the apparatus or the central device (e.g., central device 510) performs operations associated with channel sounding delegation.

As shown in FIG. 10, in some aspects, process 1000 may include transmitting, to a first peripheral device, a channel sounding request that indicates delegation of channel sounding to a second peripheral device (block 1010). For example, the central device (e.g., using transmission component 1104 and/or communication manager 1106, depicted in FIG. 11) may transmit, to a first peripheral device, a channel sounding request that indicates delegation of channel sounding to a second peripheral device, as described above.

As further shown in FIG. 10, in some aspects, process 1000 may include receiving, from the first peripheral device, a channel sounding result for the second peripheral device (block 1020). For example, the central device (e.g., using reception component 1102 and/or communication manager 1106, depicted in FIG. 11) may receive, from the first peripheral device, a channel sounding result for the second peripheral device, as described above.

Process 1000 may include additional aspects, such as any single aspect or any combination of aspects described below and/or in connection with one or more other processes described elsewhere herein.

In a first aspect, the channel sounding request indicates a number of peer devices for channel sounding.

In a second aspect, alone or in combination with the first aspect, the first peripheral device has an asynchronous connectionless link to the central device on behalf of both the first peripheral device and the second peripheral device.

In a third aspect, alone or in combination with one or more of the first and second aspects, the channel sounding result includes ranging data for the second peripheral device.

In a fourth aspect, alone or in combination with one or more of the first through third aspects, the channel sounding request includes one or more parameters that the second peripheral device is to use for delegating channel sounding.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a central device or a peripheral device, or a central device or a peripheral device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIGS. 1 and 3. As shown, the apparatus 1100 may communicate with another apparatus 1108, such as a central device or a peripheral device, using the reception component 1102 and the transmission component 1104. The communication manager 1106 may be included in, or implemented via, a processing system (for example, the processor(s) 302 described in connection with FIG. 3) of the device.

In some aspects, the apparatus 1100 may be configured to perform one or more operations described herein in connection with FIGS. 1-7B. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the device described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the device described above in connection with FIG. 3.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the device described above in connection with FIG. 3. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some aspects associated with a first peripheral device, the reception component 1102 may receive a channel sounding request from a central device. The transmission component 1104 may transmit channel sounding information to a second peripheral device. The reception component 1102 may receive a channel sounding result from the second peripheral device. The transmission component 1104 may transmit the channel sounding result to the central device.

The transmission component 1104 may transmit the channel sounding information to one or more other peripheral devices based at least in part on the number of peer devices. The reception component 1102 may receive a respective channel sounding result from each of the one or more other peripheral devices. The transmission component 1104 may transmit each of the respective channel sounding results to the central device.

In some aspects associated with a second peripheral device, the reception component 1102 may receive channel sounding information from a first peripheral device. The transmission component 1104 may transmit a channel sounding message. The reception component 1102 may receive a channel sounding response. The transmission component 1104 may transmit a channel sounding result based at least in part on the channel sounding response.

In some aspects associated with a central device, the transmission component 1104 may transmit, to a first peripheral device, a channel sounding request that indicates delegation of channel sounding to a second peripheral device. The reception component 1102 may receive, from the first peripheral device, a channel sounding result for the second peripheral device.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a first peripheral device, comprising: receiving a channel sounding request from a central device;
transmitting channel sounding information to a second peripheral device; receiving a channel sounding result from the second peripheral device; and transmitting the channel sounding result to the central device.
Aspect 2: The method of Aspect 1, wherein the channel sounding request includes an indication to delegate channel sounding to the second peripheral device.
Aspect 3: The method of any of Aspects 1-2, wherein the channel sounding request indicates a number of peer devices for channel sounding.
Aspect 4: The method of Aspect 3, further comprising transmitting the channel sounding information to one or more other peripheral devices based at least in part on the number of peer devices.
Aspect 5: The method of Aspect 4, further comprising: receiving a respective channel sounding result from each of the one or more other peripheral devices; and transmitting each of the respective channel sounding results to the central device.
Aspect 6: The method of any of Aspects 1-5, wherein the first peripheral device has an asynchronous connectionless link to the central device on behalf of both the first peripheral device and the second peripheral device.
Aspect 7: The method of any of Aspects 1-6, wherein the channel sounding result includes ranging data for the second peripheral device.
Aspect 8: The method of any of Aspects 1-7, wherein the channel sounding information includes one or more parameters that the second peripheral device is to use for delegating channel sounding.
Aspect 9: A method of wireless communication performed by a second peripheral device, comprising: receiving channel sounding information from a first peripheral device; transmitting a channel sounding message; receiving a channel sounding response; and transmitting a channel sounding result based at least in part on the channel sounding response.
Aspect 10: The method of Aspect 9, wherein the channel sounding information includes an indication that channel sounding is delegated to the second peripheral device.
Aspect 11: The method of any of Aspects 9-10, wherein the channel sounding information indicates one or more parameters for channel sounding.
Aspect 12: The method of any of Aspects 9-11, wherein the first peripheral device has an asynchronous connectionless link to a central device on behalf of both the first peripheral device and the second peripheral device.
Aspect 13: The method of any of Aspects 9-12, wherein the channel sounding result includes ranging data for the second peripheral device.
Aspect 14: The method of any of Aspects 9-13, wherein the channel sounding information includes one or more parameters that the second peripheral device is to use for delegating channel sounding.
Aspect 15: A method of wireless communication performed by a central device, comprising: transmitting, to a first peripheral device, a channel sounding request that indicates delegation of channel sounding to a second peripheral device; and receiving, from the first peripheral device, a channel sounding result for the second peripheral device.
Aspect 16: The method of Aspect 15, wherein the channel sounding request indicates a number of peer devices for channel sounding.
Aspect 17: The method of any of Aspects 15-16, wherein the first peripheral device has an asynchronous connectionless link to the central device on behalf of both the first peripheral device and the second peripheral device.
Aspect 18: The method of any of Aspects 15-17, wherein the channel sounding result includes ranging data for the second peripheral device.
Aspect 19: The method of any of Aspects 15-18, wherein the channel sounding request includes one or more parameters that the second peripheral device is to use for delegating channel sounding.
Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.
Aspect 21: An apparatus for wireless communication at a device, the apparatus comprising one or more memories and one or more processors coupled to the one or more memories, the one or more processors configured to cause the device to perform the method of one or more of Aspects 1-19.
Aspect 22: An apparatus for wireless communication, the apparatus comprising at least one means for performing the method of one or more of Aspects 1-19.
Aspect 23: A non-transitory computer-readable medium storing code for wireless communication, the code comprising instructions executable by one or more processors to perform the method of one or more of Aspects 1-19.
Aspect 24: A non-transitory computer-readable medium storing a set of instructions for wireless communication, the set of instructions comprising one or more instructions that, when executed by one or more processors of a device, cause the device to perform the method of one or more of Aspects 1-19.
Aspect 25: A device for wireless communication, the device comprising a processing system that includes one or more processors and one or more memories coupled with the one or more processors, the processing system configured to cause the device to perform the method of one or more of Aspects 1-19.
Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first peripheral device, comprising:
one or more memories; and
one or more processors coupled to the one or more memories, the one or more processors individually or collectively configured to cause the first peripheral device to:
receive a channel sounding request from a central device;
transmit channel sounding information to a second peripheral device;
receive a channel sounding result from the second peripheral device; and
transmit the channel sounding result to the central device.

2. The apparatus of claim 1, wherein the channel sounding request includes an indication to delegate channel sounding to the second peripheral device.

3. The apparatus of claim 1, wherein the channel sounding request indicates a number of peer devices for channel sounding.

4. The apparatus of claim 3, wherein the one or more processors are individually or collectively configured to cause the first peripheral device to transmit the channel sounding information to one or more other peripheral devices based at least in part on the number of peer devices.

5. The apparatus of claim 4, wherein the one or more processors are individually or collectively configured to cause the first peripheral device to:
receive a respective channel sounding result from each of the one or more other peripheral devices; and
transmit each of the respective channel sounding results to the central device.

6. The apparatus of claim 1, wherein the first peripheral device has an asynchronous connectionless link to the central device on behalf of both the first peripheral device and the second peripheral device.

7. The apparatus of claim 1, wherein the one or more processors are individually or collectively configured to cause the first peripheral device to range data for the second peripheral device.

8. The apparatus of claim 1, wherein the channel sounding information includes one or more parameters that the second peripheral device is to use for delegating channel sounding.

9. An apparatus for wireless communication at a second peripheral device, comprising:
one or more memories; and
one or more processors coupled to the one or more memories, the one or more processors individually or collectively configured to cause the second peripheral device to:
receive channel sounding information from a first peripheral device;
transmit a channel sounding message;
receive a channel sounding response; and
transmit a channel sounding result based at least in part on the channel sounding response.

10. The apparatus of claim 9, wherein the channel sounding information includes an indication that channel sounding is delegated to the second peripheral device.

11. The apparatus of claim 9, wherein the channel sounding information indicates one or more parameters for channel sounding.

12. The apparatus of claim 9, wherein the first peripheral device has an asynchronous connectionless link to a central device on behalf of both the first peripheral device and the second peripheral device.

13. The apparatus of claim 9, wherein the one or more processors are further configured to cause the second peripheral device to range data for the second peripheral device.

14. The apparatus of claim 9, wherein the channel sounding information includes one or more parameters that the second peripheral device is to use for delegating channel sounding.

15. An apparatus for wireless communication at a central device, comprising:
one or more memories; and
one or more processors coupled to the one or more memories, the one or more processors configured to cause the central device to:
transmit, to a first peripheral device, a channel sounding request that indicates delegation of channel sounding to a second peripheral device; and
receive, from the first peripheral device, a channel sounding result for the second peripheral device.

16. The apparatus of claim 15, wherein the channel sounding request indicates a number of peer devices for channel sounding.

17. The apparatus of claim 15, wherein the first peripheral device has an asynchronous connectionless link to the central device on behalf of both the first peripheral device and the second peripheral device.

18. The apparatus of claim 15, wherein the one or more processors are individually or collectively configured to cause the central device to range data for the second peripheral device.

19. The apparatus of claim 15, wherein the channel sounding request includes one or more parameters that the second peripheral device is to use for delegating channel sounding.
